(19) United States
(12) Patent Application Publication
(10) Pub. No.: US 2019/0033336 A1
(43) Pub. Date: Jan. 31, 2019

(54) Electronic device and method for estimating a displacement of a scene observed by a drone, electronic apparatus for calculating a ground speed of the drone, related drone and computer program

(71) Applicant: PARROT DRONES, Paris (FR)

(72) Inventor: Fabien Remond, L'HAY LES ROSES (FR)

(21) Appl. No.: 16/043,942

(22) Filed: Jul. 24, 2018

(30) Foreign Application Priority Data
Jul. 25, 2017 (FR) 17 57074

(51) Int. Cl. G01P 3/38; G06T 7/246

(52) U.S. Cl. CPC G01P 3/38; G06T 2207/10032; G06T 7/246

(57) ABSTRACT

A electronic device for estimating a displacement of a scene observed by an image sensor equipping a drone comprises a first module for acquiring a series of images of the scene, taken by the image sensor, and a module for estimating, via an optical flow algorithm applied iteratively at several successive levels, a displacement of the scene between an acquired prior image and current image, the level of the image being a sub-sampled image of the image of the following level, the final level being the acquired image. The estimating module calculates at least one estimate of the displacement of the scene at each level, the prior image being translated by an estimated displacement, during the passage from one level to the next. The estimating module is further configured to determine integer rounding of the estimated displacement, the prior image then being translated by the rounded displacement, during the passage from one respective level to the next.

### CROSS-REFERENCE TO RELATED APPLICATIONS

This application claims priority from French Patent Application No. 17 57074 filed on Jul. 25, 2017. The content of this application is incorporated herein by reference in its entirety.

### FIELD

The present invention includes an electronic device for estimating a displacement of a scene observed by an image sensor equipping a drone. The estimating device comprises a first acquisition module configured to acquire a series of images of the scene, taken by the image sensor, and an estimating module configured to calculate an estimate, via an optical flow algorithm, of a displacement of the scene between an acquired prior image and an acquired current image.

The invention also relates to an electronic apparatus for calculating a ground speed of the drone, the apparatus comprising a second acquisition module configured to acquire a measured altitude, such an estimating device configured to estimate a displacement of terrain overflown by the drone, and a calculating module configured to calculate the ground speed of the drone, from the acquired measured altitude and the estimated displacement of the terrain.

The invention also relates to a drone comprising such an electronic apparatus for calculating the ground speed of the drone.

The invention also relates to a method for estimating a displacement of the scene observed by the image sensor equipping the drone, the method being carried out by such an electronic estimating device.

The invention also relates to a non-transitory computer-readable medium including a computer program including software instructions which, when executed by a computer, carry out such an estimating method.

### BACKGROUND

The invention relates to the field of drones, i.e., remotely-piloted flying motorized apparatuses. The invention in particular applies to rotary-wing drones, such as quadricopters, while also being applicable to other types of drones, for example fixed-wing drones.

The invention is particularly useful for precisely calculating a speed of the drone, in particular a ground speed of the drone, in order to better control the drone based on a given speed input.

The invention is also useful for controlling the drone to remain immobile, when the pilot does not send a command, even if there are outside disruptions such as wind.

The invention is also particularly useful when the drone is in a tracking mode in order to track a given target, such as the pilot of the drone engaging in an athletic activity, and must then be capable of precisely estimating a displacement of a scene observed by an image sensor equipping the drone, and further calculating a ground speed of the drone with good precision, for effective tracking of the target.

Known from document EP 2,400,460 A1 are an electronic device and a method for estimating a differential displacement of a scene captured by a vertical camera equipping a drone, this estimated differential displacement then making it possible to assess the horizontal speed of the drone.

The estimate of the displacement comprises continuously periodically updating a multi-resolution depiction of the image pyramid type, modeling, at different decreasing successive resolutions, a same captured image of the scene, and for each new captured image, applying to said multiresolution depiction, an iterative algorithm of the optical flow type making it possible to estimate the differential movement of the scene from one image to the next.

The estimate of the displacement further comprises, under certain condition(s), switching from the optical flow algorithm to a corner detector-type algorithm to estimate the differential movement of the scene from one image to the next.

The principles of the so-called optical flow algorithm are for example described in the following documents: “An Iterative Image Registration Technique with an Application to Stereo Vision” by Lucas B. D. and Kanade T. in Proc. DARPA Image Understanding Workshop, pp. 121-130, in 1981; “Determining Optical Flow” by Horn B. K. P. and Schunk B. in Artificial Intelligence, (17):185-204, in 1981; and “3D Pose Estimation Based on Planar Object Tracking for UAVs Control ” by Mondragon I. et al. in Proc. IEEE Conference on Robotics and Automation, pp. 35-41, in May 2010. The article by Mondragon I. et al. describes a multiresolution technique for estimating the optical flow with different resolutions to pilot the landing of a drone.

However, such an estimate is not always optimal.

### SUMMARY OF THE INVENTION

The aim of the invention is then to propose an electronic device and an associated method that enable a more effective estimate of a displacement of a scene observed by an image sensor equipping a drone.

To that end, the present invention includes an electronic device for estimating a displacement of a scene observed by an image sensor equipping a drone, the device comprising:

a first acquisition module configured to acquire a series of images of the scene, taken by the image sensor,

an estimating module configured to calculate an estimate, via an optical flow algorithm, of a displacement of the scene between an acquired prior image and an acquired current image, the optical flow algorithm being applied iteratively at several successive levels, the image associated with a respective level being a sub-sampled image of the image associated with the following level, the image associated with the final level being the acquired image,

the estimating module being configured to calculate at least one estimate of the displacement of the scene at each level, the prior image further being translated by a respective estimated displacement, during the passage from one respective level to the next,

the estimating module further being configured to determine a rounding to the integer value of the respective estimated displacement, the prior image then being translated by the rounded displacement, during the passage from one respective level to the next.

With the estimating device of the state of the art, the value estimated via the optical flow algorithm of the displacement of the scene is a decimal value, depicted in the form of a floating-point number. The prior image is then translated by a decimal value of pixels, which involves an interpolation of the prior image translated by said estimated decimal value of pixels. Then, owing to a new iteration of the optical flow algorithm between the translated prior image and the current image, an estimate of the residual translation is obtained. The total estimated translation is then equal to the sum of the translation applied to the prior image and the residual translation calculated in this new iteration of the optical flow algorithm.

With the estimating device according to the invention, the value estimated via the optical flow algorithm of the displacement of the scene is rounded to an integer value, such as the closest integer value. The prior image is then translated by this integer value of pixels, which then makes it possible to avoid the aforementioned interpolation, done with the device of the state of the art, and therefore makes it possible to reduce the algorithmic complexity.

According to other advantageous aspects of the invention, the electronic estimating device comprises one or more of the following features, considered alone or according to all technically possible combinations:

the estimate of the displacement of the scene at each level is calculated between a prior image and a current image, and the estimating module is further configured to select a time difference between the prior image and the current image based on the displacement previously determined at the final level with the image preceding the current image, the time difference initially selected being predefined;

the images are taken at a predefined frequency by the image sensor, and the time difference between the prior image and the current image is a difference in number of images taken, acquired by the first acquisition module, the difference in number of images taken being equal to 1 when the prior image and the current image are two images taken consecutively and increasing by one unit for each additional intercalary image taken between the prior image and the current image;

the selection of the time difference between the prior image and the current image includes a hysteresis between the increase and the decrease of said time difference;

for the selection of the time difference between the prior image and the current image, the estimating module is configured to compare a current smoothed value of the estimated displacement with at least one threshold, the current smoothed value depending on a preceding smoothed value and the estimated displacement, the initial smoothed value being predefined; and

the estimating module is configured to calculate a single estimate of the displacement of the scene at each level and for each current image.

When the residual value to be estimated via the optical flow algorithm of the displacement of the scene is low, typically less than 0.5 pixels, the estimated value is rounded to 0 and the prior image is no longer translated. The iterative process, and therefore the gradient lowering, is then interrupted, which may yield a fairly imprecise result on this residual translation to be estimated. This imprecision is typically around 0.1 pixels.

When the total translation to be estimated is very small and amounts directly to this residual translation, the obtained estimate is then imprecise, with an imprecision typically around 0.1 pixels, which is significant when one is looking for small displacements, typically less than 0.5 pixels.

Then selecting a time difference between the prior image and the current image based on the displacement previously determined at the final level with the image preceding the current image, and in particular increasing the time difference between the prior image and the current image for the next iteration when the estimated value of the displacement becomes small, makes it possible to keep a satisfactory precision, by increasing the total translation to be estimated. The displacement estimated by the estimating device according to the invention then depends on the selected time difference between the prior image and the current image. The estimated final displacement is divided by the time difference used to find the displacement between 2 successive images, i.e., with a unitary time difference, when the time difference is defined in number of images acquired. The imprecision is thus significantly decreased for the small displacements to be estimated.

The invention also relates to an electronic apparatus for calculating a ground speed of a drone, the apparatus comprising:

a second acquisition module configured to acquire a measured altitude, provided by a measuring device equipping the drone,

an estimating device configured to estimate a displacement of a scene observed by an image sensor equipping the drone, the scene being a terrain overflown by the drone, and

a calculating module configured to calculate the ground speed of the drone, from the acquired measured altitude and the estimated displacement of the terrain estimated by the estimating device,

wherein the estimating device is as defined above.

The invention also relates to a drone comprising an electronic apparatus for calculating a ground speed of the drone, in which the electronic calculating apparatus is as defined above.

The invention also relates to a method for estimating a displacement of a scene observed by an image sensor equipping a drone, the method being carried out by an electronic estimating device, and comprising the following steps:

acquiring a series of images of the scene, taken by the image sensor,

estimating, via an optical flow algorithm, a displacement of the scene between an acquired prior image and current image, the optical flow algorithm being applied iteratively at several successive levels, the image associated with a respective level being a sub-sampled image of the image associated with the following level, the image associated with the final level being the acquired image,

the estimating step including calculating at least one estimate of the displacement of the scene at each level, the prior image further being translated by a respective estimated displacement, during the passage from one respective level to the next, the estimating step further including determining a rounding to the integer value of

the respective estimated displacement, the prior image then being translated by the rounded displacement, during the passage from one respective level to the next.

The invention also relates to a non-transitory computer-readable medium including a computer program including software instructions which, when executed by a computer, implement an estimating method as defined above.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic illustration of a drone comprising an image sensor configured to take a series of images of a scene and an electronic estimating device according to the invention, the estimating device including a module for estimating, via an optical flow algorithm, a displacement of the scene between an acquired prior image and an acquired current image;

FIG. 2 is a flowchart of a method for calculating the ground speed of the drone, this calculating method including an estimating method according to the invention;

FIG. 3 is a schematic illustration of a pyramid of images implemented by the estimating module of FIG. 1 via the optical flow algorithm; and

FIG. 4 is a schematic illustration of a state machine implemented by the estimating module of FIG. 1 for selecting a time difference between the prior image and the current image based on an estimated displacement with the preceding image.

### DETAILED DESCRIPTION

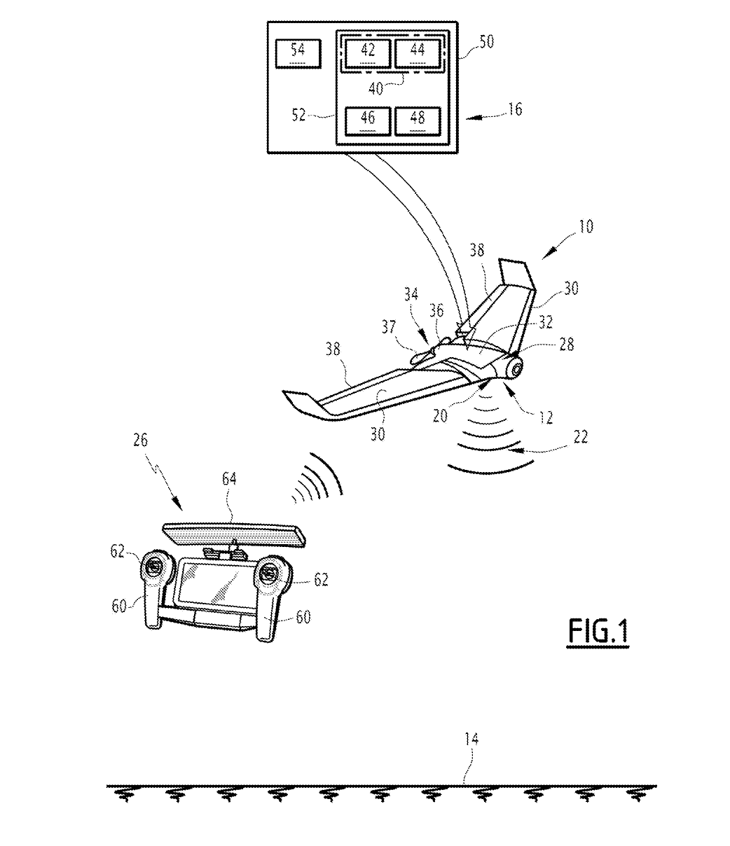

In FIG. 1, a drone 10, i.e., an aircraft with no pilot on board, comprises an image sensor 12 configured to take a series of images of a scene 14, such as a terrain overflown by the drone 10, and an electronic calculating apparatus 16 configured to calculate a ground speed of the drone 10.

The drone 10 also comprises an altimeter 20, such as a radio altimeter or an ultrasonic telemeter, emitting a beam 22 toward the ground making it possible to measure the altitude of the drone 10 relative to the terrain, i.e., relative to the ground.

As an optional addition, the drone 10 comprises a pressure sensor, not shown, also called barometric sensor, configured to determine altitude variations of the drone 10, such as instantaneous variations and/or variations relative to a reference level, i.e., relative to a predefined initial altitude. The reference level is for example the sea level, and the pressure sensor is then able to provide a measured altitude of the drone 10 relative to the sea level.

The drone 10 is a motorized flying vehicle able to be piloted remotely, in particular via a joystick 26.

The drone 10 includes a transmission module 28 configured to exchange data, preferably by radio waves, with one or several pieces of electronic equipment, in particular with the lever 26, or even with other electronic elements to transmit the image(s) acquired by the image sensor 12.

In the example of FIG. 1, the drone 10 is a fixed-wing drone, of the sailwing type. It comprises two wings 30 and a fuselage 32 provided in the rear part with a propulsion system 34 including a motor 36 and a propeller 37. Each wing 30 is provided on the side of the trailing edge with at least one control surface 38 adjustable via a servomechanism, not shown, to control the trajectory of the drone 10.

In an alternative that is not shown, the drone 10 is a rotary-wing drone, including at least one rotor, and preferably a plurality of rotors, the drone 10 then being called multi-rotor drone. The number of rotors is for example equal to 4, and the drone 10 is then a quadrirotor drone.

The image sensor 12 is known in itself, and is for example a vertical camera pointing downward.

The scene 14 is to be understood in the general sense of the term, whether it involves a scene outside or inside a building. When the scene 14 is a terrain overflown by the drone 10, the terrain is also to be understood, within the general meaning of the term, as a portion of the Earth's surface when it involves outside terrain, whether it involves a land surface or a maritime surface, or a surface including both a land portion and a maritime portion. Alternatively, the terrain is an inside terrain arranged inside a building. The terrain is also called ground.

The electronic calculating apparatus 16 is for example on board the drone 10, as shown in FIG. 1.

Alternatively, the electronic calculating apparatus 16 is a separate electronic apparatus remote from the drone 10, the electronic calculating apparatus 16 then being suitable for communicating with the drone 10, in particular with the image sensor 12, via the transmission module 28 on board the drone 10.

The electronic calculating apparatus 16 comprises an electronic estimating device 40 configured to estimate a displacement of the scene 14 observed by the image sensor 12, the estimating device 40 including a first acquisition module 42 configured to acquire a series of images of the scene 14, taken by the image sensor 12, and an estimating module 44 configured to calculate an estimate, via an optical flow algorithm, of a displacement of the scene 14 between an acquired prior image and an acquired current image.

The electronic calculating apparatus 16 comprises a second acquisition module 46 configured to acquire a measured altitude, provided by a measuring device equipping the drone 10, such as the altimeter 20.

The electronic calculating apparatus 16 comprises a calculating module 48 configured to calculate the ground speed of the drone 10, from the acquired measured altitude and the displacement of the terrain estimated by the estimating device 40, the scene 14 then being the terrain overflown by the drone 10.

In the example of FIG. 1, the electronic calculating apparatus 16 comprises an information processing unit 50, for example made up of a memory 52 and a processor 54, such as a processor of the GPU (Graphics Processing Unit) or VPU (Vision Processing Unit) type associated with the memory 52.

The lever 26 is known in itself, and makes it possible to pilot the drone 10. In the example of FIG. 1, the lever 26 comprises two gripping handles 60, each being intended to be grasped by a respective hand of the pilot, a plurality of control members, including two joysticks 62, each being arranged near a respective gripping handle 60 and being intended to be actuated by the pilot, preferably by a respective thumb. Alternatively, not shown, the lever 26 is implemented by a smartphone or electronic tablet, as known in itself.

The control stick 26 also comprises a radio antenna 64 and a radio transceiver, not shown, for exchanging data by radio waves with the drone 10, both uplink and downlink.

The electronic estimating device 40 is for example on board the drone 10, as shown in FIG. 1.

Alternatively, the electronic estimating device 40 is a separate electronic device remote from the drone 10, the electronic estimating device 40 then being suitable for communicating with the drone 10, in particular with the image sensor 12, via the transmission module 28 on board the drone 10.

The electronic estimating device 40 comprises the first acquisition module 42 and the estimating module 44. It is for example made up of the first acquisition module 42 and the estimating module 44.

In the example of FIG. 1, the first acquisition module 42 and the estimating module 44, as well as the second acquisition module 46 and the calculating module 48, are each made in the form of software executable by the processor 54. The memory 52 of the information processing unit 50 is then able to store first acquisition software configured to acquire a series of images of the scene 14, taken by the image sensor 12. The memory 52 of the information processing unit 50 is able to store estimating software configured to calculate an estimate, via the optical flow algorithm, of the displacement of the scene 14 between the acquired prior image and current image. The memory 52 of the information processing unit 50 is also able to store second acquisition software configured to acquire a measured altitude provided by the measuring device equipping the drone 10, such as the altimeter 20, and calculating software configured to calculate the ground speed of the drone 10, from the acquired measured altitude and the displacement of the terrain estimated by the estimating software. The processor 54 of the information processing unit 50 is then able to execute the first acquisition software, the estimating software, the second acquisition software and the calculating software.

In an alternative that is not shown, the first acquisition module 42 and the estimating module 44, as well as the second acquisition module 46 and the calculation module 48, are each made in the form of a programmable logic component, such as an FPGA (Field Programmable Gate Array), or in the form of a dedicated integrated circuit, such as an ASIC (Applications Specific Integrated Circuit).

The first acquisition module 42 is configured to acquire at least two images of the scene 14, taken by the image sensor 12, the displacement of the scene 14 estimated by the estimating module 44 being calculated between the acquired prior image and current image. The first acquisition module 42 is in particular configured to acquire a series of images of the scene 14, these images having been taken by the sensor 12. The first acquisition module 42 is preferably configured to acquire the images of the scene 14 regularly by the sensor 12, or as the images are taken by the sensor 12.

The estimating module 44 is configured to calculate an estimate of the displacement of the scene 14 between the acquired prior image and current image via the optical flow algorithm.

The optical flow algorithm makes it possible to estimate a differential movement of the scene 14 from one image to the following image, and different known methods exist for implementing the optical flow algorithm, for example the Lucas-Kanade method, the Horn-Schunk method, or the Farneback method.

The Lucas-Kanade estimating method is particularly quick and easy, given that there is a locally constant optical flow, i.e., the movement of which is the same for each point of the scene 14 captured by the image sensor 12. This hypothesis is verified if the scene 14 is perfectly flat, if the movement is parallel to the focal plane of the image sensor 12 and without rotation around the optical axis of the image sensor 12, and with a constant illumination of the scene 14.

Other examples of the implementation of an optical flow algorithm are also described in the documents “Optic-Flow Based Control of a 46g Quadrotor” by Briod et al, “Optical Flow Based Velocity Estimation for Vision based Navigation of Aircraft” by Julin et al, and “Distance and velocity estimation using optical flow from a monocular camera” by Ho et al.

The optical flow algorithm is further implemented in a so-called multi-resolution technique, suitable for estimating the optical flow with different successive image resolutions, starting from a low resolution up to a high resolution.

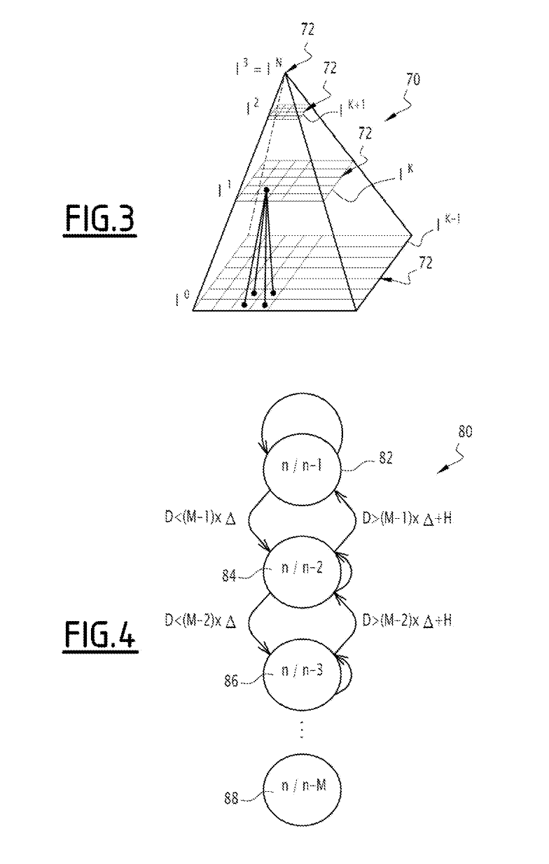

The optical flow algorithm is then for example an iterative algorithm with a pyramidal-type implementation, as shown in FIG. 3, the pyramid 70 including several levels 72 and the image I^{K} associated with the respective level K being a sub-sampled image of the image I^{K-1} associated with the following level K−1. K is an index representing the level and comprised between 0 and N while evolving in a decreasing manner, N designating the initial level and 0 designating the final level.

In other words, the optical flow algorithm is applied iteratively to several successive levels K, K−1, the image I^{K} associated with a respective level K being a sub-sampled image of the image I^{K-}1 associated with a following level K−1, the image I⁰ associated with the final level 0 being the acquired image.

The most sub-sampled image I^{N} then corresponds to the initial level N of the iterative algorithm, or to the top level of the pyramid. The image I⁰ associated with the final level 0of the iterative algorithm, or the bottom level of the pyramid, is the image as acquired by the first acquisition module 42. In other words, the image I⁰ associated with the final level 0 is not sub-sampled.

The sub-sampling factor F from a level K to the preceding level K+1 is for example equal to 2. The number of levels 72 of the iterative algorithm, equal to N+1, is for example comprised between 2 and 4, preferably equal to 3. In other words, N is for example comprised between 1 and 3, preferably equal to 2.

As an example, the complete image at level 0 has a resolution of 176×144 pixels, the image at level 1 has a resolution of 88×72 pixels, that at level 2 of 44×36 pixels, and that at level 3 of 22×18 pixels, N being equal to 3 in this example.

The sub-sampling of the image I^{K} associated with a level K relative to the image I^{K-1} associated with the following level K−1 is for example obtained by calculating each pixel of the image I^{K} from F² pixels of the image I^{K-1}, each pixel of the image I^{K} for example being an average of F² corresponding pixels of the image I^{K-1}, F representing the sub-sampling factor. In the example of FIG. 3, F is equal to 2, and each pixel of the image I^{K} then depends on 4 pixels of the image I^{K-1}, while for example being an average of these 4 pixels.

The precision of the estimated optical flow is then inversely proportional to the reduction done; in contrast, the corresponding maximum detectable speed increases in proportion to the reduction level. The multiresolution approach consists of estimating the constant optical flow in the lowest resolution, i.e., the level N, then re-injecting this result as prediction in the following resolution, i.e., the level N−1, and so forth. This prediction injected in the following resolution is resized for this following resolution. The advantage of initially working on a rough version of the image, i.e., the most sub-sampled image I^{N}, lies in the fact that only a very small displacement is allowed in the image and the tracking of the points is then very fast. The movement information thus obtained is then usable to predict the movement in the lower-level image. The progression is thus done from level to level until obtaining a sufficient precision.

Alternatively, the estimate is done from level 3 (three successive reductions) to level 1 (one reduction), which makes it possible to obtain a precise result extremely quickly. The abandonment of level 0 (complete image) makes it possible, according to this alternative, to save about 75% of the calculations, which provides an effective compromise between calculation time and precision of the result.

As an optional addition, the optical flow algorithm is combined with another image processing algorithm, in particular with an algorithm of the corner detector type, in order to improve the estimate of the differential movement of the scene from one image to the next, as described in document EP 2,400,460 A1.

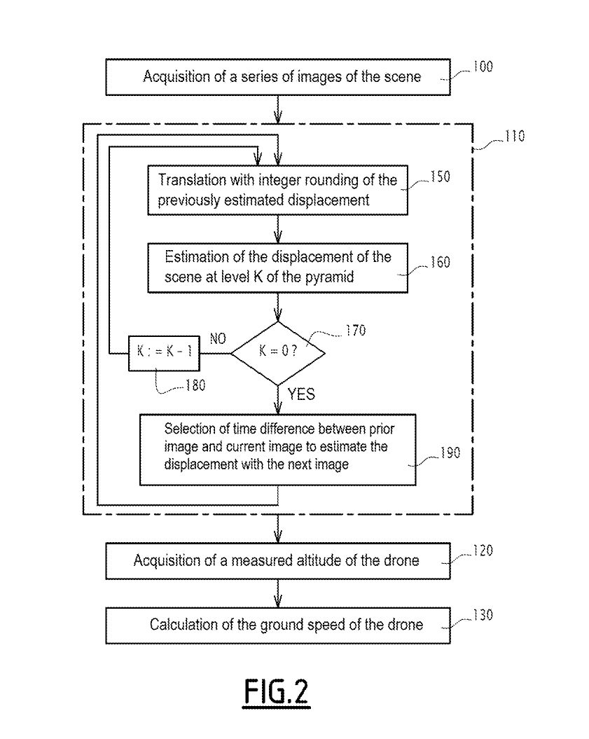

The estimating module 44 is configured to calculate at least one estimate of the displacement of the scene 14 at each level K, this estimate being calculated between a prior image and a current image. The prior image is further translated by a respective estimated displacement, during the passage from a respective level K to the following level K−1, and for example prior to each estimate, as shown in FIG. 2. When the translation is done before the estimate, the estimating module 44 is configured to perform the translation prior to the initial level 0 from the estimated displacement to the final level for the preceding image.

The estimating module 44 is preferably configured to calculate a single estimate of the displacement of the scene 14 at each level K and for each current image.

Alternatively, the estimating module 44 is configured to calculate several estimates, such as at least three estimates, of the displacement of the scene 14 for at least one level and for each current image. One skilled in the art will then understand that the number of estimates calculated at each level is a compromise between precision of the calculation and calculation time, the calculation being even more precise when the number of estimates calculated at each level is high, in particular for the last level, i.e., the level with the best resolution, such as level 0 or 1, the calculation time also being longer when the number of estimates calculated at each level is high. According to this alternative, the estimating module 44 is configured to calculate several estimates of the displacement of the scene 14 preferably for the last level, i.e., the level with the best resolution, such as level 0 or 1, and for each current image.

According to the invention, the estimating module 44 is further configured to determine a rounding to the integer value of the respective estimated displacement for the translation of the prior image during the passage from one respective level K to the next K−1, the prior image then being translated by the rounded displacement. The rounding is preferably a rounding to the closest integer value to the estimated displacement.

As an optional addition, the estimating module 44 is further configured to select a time difference between the prior image and the current image based on the displacement previously determined at the final level with the image preceding the current image, the time difference initially selected being predefined. The selection of the time difference is preferably done after estimating the displacement of the scene 14 at the final level 0, in order to estimate the displacement for a new acquired image then corresponding to the next current image from which the iterative optical flow algorithm will be applied.

The images are taken at a predefined frequency by the image sensor 12, and the time difference between the prior image and the current image is preferably a difference in number of images taken, acquired by the first acquisition module 42.

The difference in number of images taken is for example equal to 1 when the prior image and the current image are two images taken consecutively and increases by one unit for each additional intercalary image taken between the prior image and the current image.

For the selection of the time difference by the estimating module 44, the difference expressed in number of images is for example less than or equal to 5, preferably less than or equal to 3.

According to this optional addition, the estimated displacement then depends on the selected time difference between the prior image and the current image, and the estimating module 44 is preferably further configured to divide the estimated final displacement by the selected time difference. This then makes it possible to estimate the displacement between two successive images, i.e., with a unitary time difference, when the time difference is defined in number of images taken. One skilled in the art will further understand that when the time difference is defined in the form of a time value, then the estimating module 44 is preferably further configured to multiply the estimated final displacement by a ratio between a predefined time period and the selected time difference, in order to estimate the displacement between two successive images. The predefined time period then corresponds to the time period between two successive images, or two image acquisitions by the image sensor 12, i.e., the inverse of the predefined image acquisition frequency of the image sensor 12.

Also as an optional addition, the estimating module 44 is configured to select the time difference between the prior image and the current image with a hysteresis between the increase and the decrease of said time difference.

Also as an optional addition, for the selection of the time difference between the prior image and the current image, the estimating module 44 is configured to compare a current smoothed value D of the estimated displacement with at least one threshold, the current smoothed value D depending on a preceding smoothed value and on the estimated displacement, the initial smoothed value being predefined.

In the example of FIG. 4, the estimating module 44 is then configured to implement a finite state machine 80 in order to select the time difference as a function of the displacement previously determined, such as the current smoothed value D of the estimated displacement.

In this example of FIG. 4, the time difference is expressed in the form of integer values, and this difference is equal to 1 in an initial state 82 of the finite state machine 80, the difference equal to 1 corresponding to two images taken consecutively, such as images with indices n and n−1, as previously indicated.

The estimating module 44 is configured to stay in this initial state 82 with a difference equal to 1 as long as the current smoothed value D of the estimated displacement is greater than or equal to (M−1)×Δ, where M is a predefined maximum difference, expressed in number of images, and Δ is a predefined threshold expressed in the same unit as the current smoothed value D of the estimated displacement.

Δ is typically expressed in number of pixels, and for example equal to 2 pixels (px). M also corresponds to the number of states of the finite state machine 80, and is for example equal to 3.

The estimating module 44 is configured to enter a following state 84 of the finite state machine 80 when the current smoothed value D of the estimated displacement is less than (M−1)×Δ, this following state 84 corresponding to a difference equal to 2, i.e., the two images separated by an intercalary image, such as images with indices n and n−2.

In the example where M=3 and Δ=2 px, the estimating module 44 is then configured to stay in the initial state 82 if the current smoothed value D is greater than or equal to 4 pixels, and to enter the following state 84 corresponding to the difference equal to 2 if this current smoothed value D is strictly less than 4 pixels.

The estimating module 44 is configured to stay in this following state 84 of the finite state machine 80 corresponding to the difference equal to 2, if the current smoothed value D of the estimated displacement is greater than or equal to (M−2)×Δ, while being less than or equal to (M−1)×Δ+H, where H represents a hysteresis value expressed in the same unit as the current smoothed value D and the predefined threshold Δ.

H is typically expressed in number of pixels, and for example equal to 0.5 px.

In this example where M=3, Δ=2 px and H=0.5 px, the estimating module 44 is then configured to stay in this following state 84 corresponding to the difference equal to 2 while the current smoothed value D is comprised between 2 pixels and 4.5 pixels, and to return to the initial state 82 corresponding to the difference equal to 1 only when the current smoothed value D is strictly greater than 4.5 pixels.

Similarly, the estimating module 44 is configured to enter a following state 86 of the finite state machine 80 when the current smoothed value D of the estimated displacement is less than (M−2)×Δ, this following state 86 corresponding to a difference equal to 3, i.e., the two images separated by two intercalary images, such as images with indices n and n−3. The estimating module 44 is configured to stay in this following state 86 corresponding to the difference equal to 3, while the current smoothed value D of the estimated displacement is greater than or equal to (M−3)×Δ, while being less than or equal to (M−2)×Δ+H, and so forth until the final state 88.

In this example where M=3, Δ=2 px and H=0.5 px, the estimating module 44 is then configured to enter the following state 86 corresponding to the difference equal to 3 if the current smoothed value D is strictly less than 2 pixels, then to stay in this following state 86 while the current smoothed value D is comprised between 0 pixels and 2.5 pixels, this following state 86 in fact here corresponding to the final state 88, M being equal to 3, and lastly to return to the preceding state 84 associated with the difference equal to 2 only when the current smoothed value is strictly greater than 2.5 pixels.

The smoothed value of the displacement, also called current smoothed value D of the estimated displacement, is preferably an exponentially smoothed value, and for example verifies the following equation:

D:=α·D+(1−α)·Trans (1)

where α represents a smoothing constant,

Trans represents the value of the estimated displacement, preferably expressed in the form of a decimal value in number of pixels;

or the following equation:

Dₚ=α·Dₚ₋₁+(1−α)·Trans (2)

where Dₚ and Dₚ₋₁ respectively represent the current smoothed value and the preceding smoothed value.

α is for example equal to 0.959 corresponding to a time constant of 0.4 s for an image rate of 60 images per second, and an initial value by default of Trans is for example equal to 15 pixels.

The value Trans is calculable in different ways. The optical flow algorithm for example yields an estimate in pixels in 2 dimensions (Fx, Fy) along the 2 axes characterizing the image sensor 12. Typically, the Lucas-Kanade optical flow algorithm yields this translation owing to the following formula:

$$[ \begin{matrix}{F}_{x} \\ {F}_{y}\end{matrix} ] = [ \begin{matrix}{\sum }_{E} {I}_{x}^{2} & {\sum }_{E} {I}_{x} \cdot {I}_{y} \\ {\sum }_{E} {I}_{x} \cdot {I}_{y} & {\sum }_{E} {I}_{y}^{2}\end{matrix} ] \cdot [ \begin{matrix}{\sum }_{E} {I}_{x} \cdot {I}_{t} \\ {\sum }_{E} {I}_{y} \cdot {I}_{t}\end{matrix} ] \qquad ( 3 )$$

Ix and Iy being the components of the gradient of the image, and

E being the set of points for which the gradient has a norm greater than a first predetermined useful threshold.

It is also possible to obtain an estimate in 3 dimensions (Tx, Ty, Tz), by using a movement model of the drone, as a translation into 3 dimensions. This then requires an adaptation of the optical flow algorithm to account for the fact that the movement model induces different translations depending on the zone of the image.

In the case of an output in 3 dimensions (Tx, Ty, Tz), the latter is for example expressed as a translation into 3 dimensions of the drone 10 in meters, with a height of 1 meter. This hypothesis of a height of 1 meter is used because the optical flow algorithm does not know the height of the drone 10, and its result depends on this height. The value Trans is then for example calculated using the following equation:

Trans−{square root over (|ƒTₓ|+|cₓ·T_{z}|)²+(|ƒ·T_{y}|+|c_{y}·T_{z}|)²)} (4)

where f represents the focal distance of the sensor 12, expressed in pixels, and cₓ, C_{y} represent the coordinates in pixels of the optical center.

The estimating module 44 is then configured to use, as value of the estimated displacement of the scene 14 for each new image, preferably that of the level with the best resolution, i.e., level 0, this result being the most precise. The estimated value provided as output of the estimating module 44 is a decimal value, such as a decimal value expressed in number of pixels.

The second acquisition module 46 is configured to acquire the measured altitude, such as that provided by the altimeter 20. The second acquisition module 46 is preferably configured to acquire the altitude measured by the measuring device at regular intervals, or as the altitude is measured by said measuring device. The calculating module 48 is configured to calculate the ground speed of the drone in a manner known in itself, from the acquired measured altitude and the displacement of the terrain estimated by the estimating device 40, the scene 14 then being the terrain overflown by the drone 10.

The operation of the electronic calculating apparatus 16, and in particular the electronic estimating device 40, will now be described in light of FIG. 2 showing a flowchart of the method for calculating the ground speed of the drone, this calculating method including a method for estimating the displacement of the scene 14 observed by the image sensor 12.

During an initial step 100, carried out at regular intervals, the electronic estimating device 40 acquires, via its first acquisition module 42, at least two images of the scene 14, taken beforehand by the image sensor 12. One skilled in the art will understand that images taken by the sensor 12 are preferably acquired at regular intervals by the first acquisition module 42 and stored in a buffer memory, such as a zone of the memory 52, while waiting to be taken into account by the estimating module 44 in order to estimate the displacement of the scene 14 upon each new acquired image.

The electronic estimating device 40 calculates, during the following step 110 and via its estimating module 44, an estimate, via an optical flow algorithm previously described, the displacement of the scene 14 between the acquired prior image and current image. This step for calculating the estimate 110 will be described in more detail hereinafter.

The electronic calculating apparatus 16 acquires, during the following step 120 and via its second acquisition module 46, the altitude of the drone 10 measured by the measuring device, such as the altimeter 20, this acquired measured altitude corresponding to that at which the estimate of the displacement of the scene 14 has previously been done during the previous step 110.

In other words, one skilled in the art will understand that the electronic measuring apparatus 16 preferably comprises time synchronization means for the first acquisition module 42 and the second acquisition module 44, so that the acquired image used to calculate the estimate of the displacement of the scene 14 via the optical flow algorithm temporally corresponds to the acquired measured altitude.

The electronic calculating apparatus 16 lastly calculates, during step 130 and via its calculating module 48, the ground speed of the drone 10 from the measured altitude acquired during step 120 and the displacement of the terrain estimated by the estimating device 40 during step 110, the scene 14 in this case being terrain overflown by the drone 10.

The estimating step 110 will now be described in more detail. This estimating step 110 includes a sub-step 150 for translating the prior image with the displacement previously estimated in the preceding level of the optical flow algorithm applied iteratively, or with the displacement estimated at the final level 0 for the preceding image when the optical flow algorithm is reiterated at the initial level N for a new acquired image.

According to the invention, this translation of the prior image is then done with rounding to an integer value of this previously estimated displacement, preferably rounding to the closest integer value to this estimated displacement. This rounding to the integer value of the estimated displacement is expressed in number of pixels. This then makes it possible to reduce the algorithmic complexity of this translation for the estimating module 40, and in particular to avoid having to perform an interpolation that would be necessary in the case of an estimated displacement with a decimal value in number of pixels.

The estimating step 110 includes a sub-step 160 for estimating the displacement of the scene 14 at level K of the pyramid 70 using one of the known methods for implementing the optical flow algorithm, for example the Lucas-Kanade method.

The estimating step 110 next includes a test sub-step 170 for determining whether the value of the index K representing the respective level in the optical flow algorithm applied iteratively is strictly positive or is nil. This test then makes it possible to determine when the index K is equal to 0 that the iterative algorithm has arrived at the final level corresponding to the determination of the precise estimate for the current image, or when the index K is strictly positive, that the algorithm must be reiterated at the following level with a more sampled image.

If the test performed during the sub-step 170 is negative, i.e., K>0, the estimating step 110 then includes a sub-step 180 for decrementing the index K, the index K evolving in a decreasing manner between N and 0, and being decremented by one unit upon each decrementation 180.

One skilled in the art will understand that, in the case of the alternative previously described, where the estimate is done from level 3 (three successive reductions) to level 1 (one reduction), with an abandonment of level 0 (complete image not sub-sampled), the test done during sub-step 170 consists of determining whether the value of the index K is strictly greater than 1 or equal to 1, and that the index K then evolves in a decreasing manner between N and 1.

On the contrary, when the test done during sub-step 170 is positive, i.e., K=0 or K=1 according to the aforementioned alternative, the estimating step 110 goes to a sub-step 190 for selecting the time difference between the prior image and the current image to estimate the displacement with the next image. This selection is for example made in the manner previously described using the finite state machine 80 in light of FIG. 4.

At the end of this selection sub-step 190, the estimating module 44 on the one hand provides, in particular to the calculation module 48, the calculated estimate of the displacement of the scene 14 for the current image, and on the other hand restarts the iterative optical flow algorithm for the new acquired image by returning to the translation sub-step 150.

One can thus see that the electronic estimating device 40 according to the invention and the associated estimating method enable a more effective estimate of a displacement of the scene 14 observed by the image sensor 12 equipping the drone 10, in particular through the translation of the rounded displacement to the integer value, before a new iteration of the optical flow algorithm at the next level.

Furthermore, selecting, as an optional addition, the time difference between the prior image and the current image as a function of the previously determined displacement makes it possible to keep a satisfactory precision, while increasing the total translation to be estimated when the value of the previously estimated displacement decreases.

1. An electronic device for estimating a displacement of a scene observed by an image sensor equipping a drone, the device comprising:
a first acquisition module configured to acquire a series of images of the scene, taken by the image sensor,
an estimating module configured to calculate an estimate, via an optical flow algorithm, of a displacement of the scene between an acquired prior image and an acquired current image, the optical flow algorithm being applied iteratively at several successive levels, the image associated with a respective level being a sub-sampled image of the image associated with the following level, the image associated with the final level being the acquired image,
the estimating module being configured to calculate at least one estimate of the displacement of the scene at each level, the prior image further being translated by a respective estimated displacement, during the passage from one respective level to the next,
wherein the estimating module is further configured to determine a rounding to the integer value of the respective estimated displacement, the prior image then being translated by the rounded displacement, during the passage from one respective level to the next.

2. The device according to claim 1, wherein the estimating module is further configured to select a time difference between the prior image and the current image based on the displacement previously determined at the final level with the image preceding the current image, the time difference initially selected being predefined.

3. The device according to claim 2, wherein the images are taken at a predefined frequency by the image sensor, and the time difference between the prior image and the current image is a difference in number of images taken, acquired by the first acquisition module,
the difference in number of images taken being equal to 1 when the prior image and the current image are two images taken consecutively and increasing by one unit for each additional intercalary image taken between the prior image and the current image.

4. The device according to claim 2, wherein the selection of the time difference between the prior image and the current image includes a hysteresis between the increase and the decrease of said time difference.

5. The device according to claim 2, wherein for the selection of the time difference between the prior image and the current image, the estimating module is configured to compare a current smoothed value of the estimated displacement with at least one threshold, the current smoothed value depending on a preceding smoothed value and on the estimated displacement, the initial smoothed value being predefined.

6. The device according to claim 1, wherein the estimating module is configured to calculate a single estimate of the displacement of the scene at each level and for each current image.

7. An electronic apparatus for calculating a ground speed of a drone, the apparatus comprising:
a second acquisition module configured to acquire a measured altitude, provided by a measuring device equipping the drone,
an estimating device configured to estimate a displacement of a scene observed by an image sensor equipping the drone, the scene being a terrain overflown by the drone, and
a calculating module configured to calculate the ground speed of the drone, from the acquired measured altitude and the estimated displacement of the terrain estimated by the estimating device,
wherein the estimating device is according to claim 1.

8. A drone, comprising an electronic apparatus for calculating a ground speed of the drone, wherein the electronic calculating apparatus is according to claim 7.

9. A method for estimating a displacement of a scene observed by an image sensor equipping a drone, the method being carried out by an electronic estimating device, and comprising the following steps:
acquiring a series of images of the scene, taken by the image sensor,
estimating, via an optical flow algorithm, a displacement of the scene between an acquired prior image and current image, the optical flow algorithm being applied iteratively at several successive levels, the image associated with a respective level being a sub-sampled image of the image associated with the following level, the image associated with the final level being the acquired image,
the estimating step including calculating at least one estimate of the displacement of the scene at each level, the prior image further being translated by a respective estimated displacement, during the passage from one respective level to the next,
wherein the estimating step further includes determining a rounding to the integer value of the respective estimated displacement, the prior image then being translated by the rounded displacement, during the passage from one respective level to the next.

10. A non-transitory computer-readable medium including a computer program comprising software instructions which, when executed by a computer, carry out a method according to claim 9.
